(19) United States
(12) Patent Application Publication
(10) Pub. No.: US 2005/0070221 A1
(43) Pub. Date: Mar. 31, 2005

(54) Vehicular repeater multi-unit system and method for allowing the first vehicular repeater unit on-scene to remain priority

(76) Inventor: Michael P. Upton, Tamarac, FL (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/674,833

(22) Filed: Sep. 30, 2003

(51) Int. Cl. H04B 7/15

(52) U.S. Cl. 455/11.1; 455/345

(57) ABSTRACT

A communication system (100) including a portable radio (130) selectively transmitting radio signals, a first vehicular repeater system (110) including a first vehicular repeater (112) adaptable to receive radio signals transmitted by the portable radio (130). A first mobile radio (114) is coupled to the first vehicular repeater (112) and is adaptable to retransmit signals received by the first vehicular repeater (112). The first vehicular repeater (112) has priority repeater status that signifies primary responsibility for repeating the radio signals transmitted by the portable radio (130). The first vehicular repeater (112) is also capable of responding to a notification signal received from a second vehicular repeater system (120) with a priority signal to indicate that it is to remain in priority repeater status such that the second vehicular repeater system (120) monitors to receive the priority signal by the first vehicular repeater (112) in order to determine its priority status.

### TECHNICAL FIELD

This invention relates in general to two-way, base-mobile portable communications systems and more particularly to the prioritization of vehicular repeaters when two or more vehicular repeaters are in one location.

### BACKGROUND

Vehicular repeaters are commonly used in public service applications by police, fire and other governmental agencies. As is well known in the art, vehicular repeater systems allow high-power mobile radio units to be used in extending the communications range of portable radio communications units. In operation, a vehicular repeater receives communication signals from a portable radio and retransmits these signals at higher power to enable extended range communication. Preferably, such range extension is automated such that when a portable radio is within communication range of a vehicular repeater this range extension takes place and the portable radio is able to communicate a greater distance. This type of scenario is discussed in U.S. Pat. No. 5,915,208 which is herein incorporated by reference wherein a multi-unit priority resolution algorithm used in connection with a vehicular repeater. The repeater generates a tone when activated to signal to the other vehicular repeaters in the area that the new repeater will be taking over priority becoming the primary vehicular repeater used at the scene. When the tone is received by the vehicular repeater already on-scene, the repeater will increment its priority state and allow the unit that just arrived to take control of repeated communications. In this application, each time a new unit arrives at the scene, it will take control of repeated communications. Thus, the late unit to arrive will become the priority vehicular repeater.

One problem associated with this type of arrangement is in situations where a vehicular repeater is used by a fire department. In this application, the first truck to arrive at the scene of a fire often has the best location as it is tactically situated to the fire. It would then be a disadvantage to have subsequent fire trucks with vehicular repeaters arrive at the scene to take control where the repeater in the first truck already has an optimal location. In this case, the first truck would not remain the priority repeater. Moreover, once the repeater is set up on the proper channel, any newly arriving vehicular repeater may not be set up correctly on the proper communications channel. If the newly arriving unit takes control of the repeated communications, some of the on-going communications could be disrupted since the new repeater may not be set to operate on the communications channel currently being used. Consequently, the need exists to provide a system and method in specialized situations wherein a vehicular repeater which is first on-scene can remain the priority repeater while still permitting other vehicular repeaters to assume priority in those situations where the primary repeater fails or is deactivated.

### SUMMARY OF THE INVENTION

Briefly, according to the invention, there is provided a vehicular repeater multi-system and method for allowing a first vehicular repeater unit that arrives on-scene to remain as the priority vehicular repeater to other arriving repeaters. In accordance with the invention, after a newly arriving vehicular repeater arrives on-scene, it is activated such that it then transmits an RF notification signal. This notifies other repeaters in the operational area that a new repeater has arrived. It then monitors for receipt of a priority signal from any other vehicular repeaters that may already be in the operational area that wish to remain the priority repeater for that area. If a priority signal is detected, the newly arriving vehicular repeater then moves to an idle and/or non-operational state. If however no priority signal is detected, the newly arriving vehicular repeater assumes control as the primary vehicular repeater for that operational area.

### BRIEF DESCRIPTION OF THE DRAWINGS

The features of the present invention, which are believed to be novel, are set forth with particularly in the appended claims. The invention, together with further objects and advantages thereof, may best be understood by reference to the following description, taken in conjunction with the accompanying drawings, in the several figures of which like reference numerals identify like elements, and in which:

FIG. 1 is a diagram of a radio communications system employing vehicular repeaters according to a particular priority scheme.

FIG. 2 is a block diagram of a vehicular repeater system as used in connection with the present invention.

FIG. 3 is a diagram showing the communications system as seen in FIG. 1 and operation of a typical prioritization scheme.

FIG. 4 is a block diagram showing operation of the method using an analog signal tone for maintaining priority of a priority unit in accordance with the present invention.

FIG. 5 is a block diagram showing operation of the method using a digital signal tone for maintaining priority of a priority unit in accordance with an alternative embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The present invention provides for a vehicular repeater system that supports automatic transitioning from a non-priority mode to a priority mode wherein the first vehicular repeater system on-scene can remain in primary control. Typically, the vehicular repeaters operate in a common communication environment according to a particular priority scheme that designates a priority vehicular repeater and at least one non-priority vehicular repeater. In normal operation, when a vehicular repeater system arrives on-scene and is activated, it will generate a tone to notify any other active vehicular repeater system within this communication environment that it will be assuming priority control of any future retransmissions. In this type of situation, the last arriving vehicular repeater to a communication environment would assume the role of priority repeater. According to the preferred method of the present invention, multiple signal tones may be used to maintain the first arriving vehicular repeater on-scene as the priority unit. This is accomplished by first transmitting a notification tone by any new vehicular repeater arriving on-scene. If a priority repeater is already active on-scene then it responds using a priority increment tone which is used by the newly activated repeater to maintain the repeater in an idle state.

As known in the art, three terms are commonly used in connection with vehicular repeaters of the present invention. The term “in priority” or “priority state” means that the unit referred to is the unit which will transmit with no delay beyond attack times, other conditions allowing transmission. “Non-priority” means that the unit referred to cannot, under any circumstances, transmit sooner than a given delay period. If, at the end of that period, a transmission is required and no contraindicating transmission is being received, that unit will transmit and will assume the priority state.

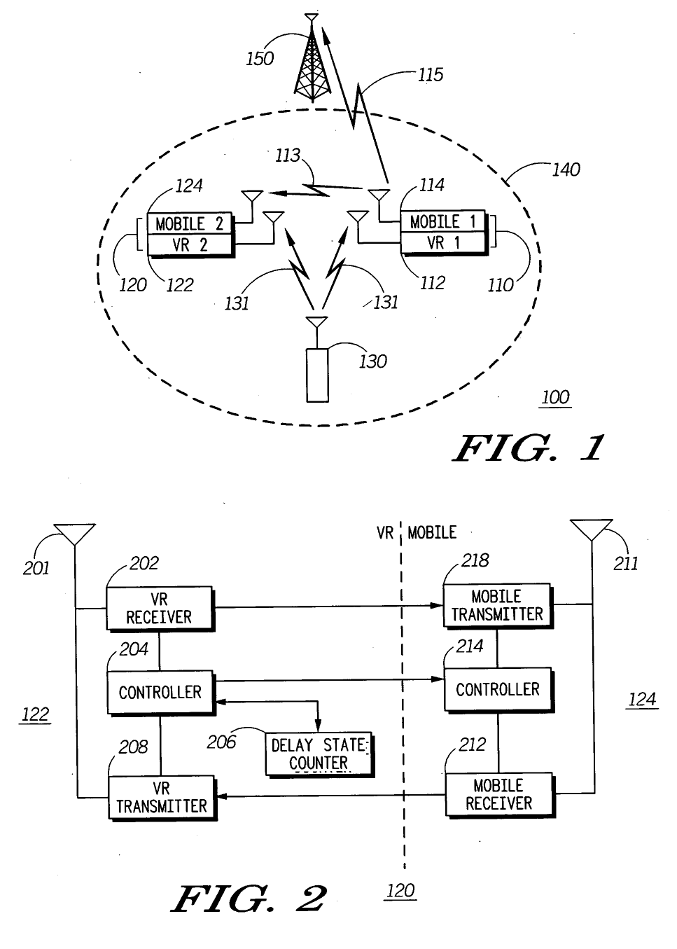

FIG. 1 is a diagram of a radio communication system 100, in accordance with the present invention. The communication system 100 includes a portable communication device 130, multiple vehicular repeater systems 110, 120, and a base station 150. The communication device 130 is a portable two-way radio capable of operating on one or more radio frequency communication channels. The portable radio 130 operates in a communication environment 140 and is within communication range of the vehicular repeater systems 110, 120. The vehicular repeaters systems 110, 120 operate according to a priority scheme that designates vehicular repeater system 110 as a priority vehicular repeater and vehicular repeater system 120 as a non-priority vehicular repeater. Although only one non-priority system is shown, there may be many operating in a particular communication environment. In the preferred embodiment, the priority scheme is based in part on a delay state and counter system in which the priority repeater ordinarily operates with a delay state of zero, and a non-priority repeater operates with a delay state of one or more time periods. A delay state of zero indicates that the vehicular repeater should retransmit any signal submitted for retransmission without any delay. A non-zero delay state signifies that the vehicular repeater is in a non-priority mode and will monitor for communication activity indicating that the priority repeater is still active. When no communication activity is detected within the delay period, a non-priority repeater will reduce its delay state which in effect will adjust its priority. The principles of one such delay state based priority scheme are taught in U.S. Pat. No. 4,056,779, issued to Toler on Nov. 1, 1977, for a Vehicular Repeater, the entire contents of which are herein incorporated by reference.

In operation, the portable radio 130 transmits a communication signal 131 which is received by the priority vehicular repeater system 110, and retransmitted to the base station 150 via signal path 115. According to the present invention, when the portable radio 130 transmits a voice communication signal, the non-priority repeater system 120 will receive the voice communication signal via signal path 131 and monitor the receiver of the mobile 124 in the non-priority system to verify that the voice communication signal was rebroadcast. The non-priority vehicular repeater system 120 takes advantage of the presence or absence of this voice communication signal at the mobile's 124 receiver in determining when to modify the priority scheme, such as to assume priority status. For example, if a repeatable signal is received by a non-priority vehicular repeater, it will determine if the receiver of the mobile to which it is coupled unsquelches to a communication signal on the designated repeat frequency. If it does unsquelch, then this indicates that another vehicular repeater which has priority is retransmitting the repeatable signal to the base station. If the mobile receiver does not unsquelch, then the non-priority vehicular repeater will, after a designated period of time, decrement a priority counter until at such time as its priority counter is equal to zero and it will assume priority.

FIG. 2 is a block diagram highlighting important functional blocks of the non-priority vehicular repeater system 120. The other vehicular repeater system 110 is similarly constructed. The vehicular repeater system 120 includes a vehicular repeater portion 122, and a mobile radio 124. The vehicular repeater portion 122 includes a receiver 202, a transmitter 208, a controller 204, and delay state counter 206. The receiver 202 operates under control of the controller 204 to receive signals for retransmission via an antenna 201. The transmitter 208 operates in conjunction with the controller to transmit signals intended for the portable receivers via the antenna 201. The delay state counter 206 operates to determine the priority status of the vehicular repeater system 120. When the delay state counter represents a delay state of zero, the vehicular repeater system 120 has priority repeater status. When the delay state counter represents a non-zero delay state, the vehicular repeater system is in non-priority mode.

The vehicular repeater 122 interfaces with the mobile radio 124 to support its retransmission functions. Thus, the vehicular repeater receiver 202 is coupled to a mobile transmitter 218, and the vehicular repeater transmitter 208 is coupled to a mobile receiver 212. The mobile transmitter 218 and the mobile receiver 212 are coupled to a mobile antenna 211. The mobile radio 124 has a controller 214 that controls the operation of the mobile transmitter 218 and mobile receiver 212. Communication between the controller 204 for the vehicular repeater 122 and the controller 214 for mobile radio 124 facilitates operation of the vehicular repeater system 120. As known in the art, the non-priority vehicular repeater system 120 typically monitors the mobile receiver 212 to detect the retransmission of a voice communication signal which is submitted to the priority vehicular repeater system for retransmission. If the retransmission of the voice communication signal is not detected within a predetermined period of time, the non-priority vehicular repeater system 120 assumes priority status thereby modifying the priority scheme governing automatic retransmissions.

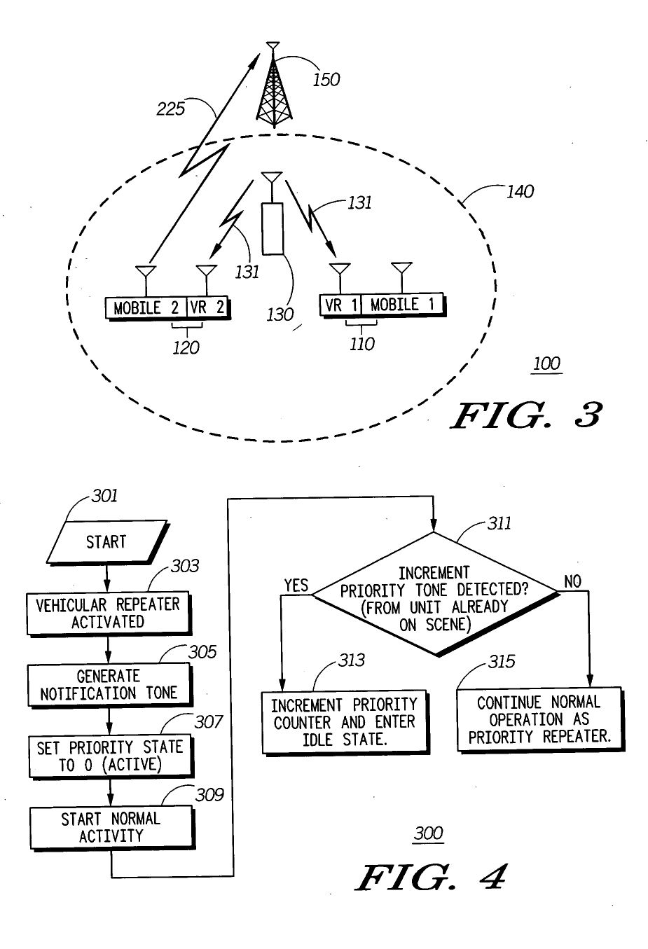

FIG. 3 depicts one method of transitioning priority repeater status from the priority vehicular repeater system 110 to the non-priority vehicular repeater system 120, when an voice signal transmitted by the portable radio 130 is not retransmitted by the priority vehicular repeater system 110. Upon the absence of the retransmitted voice signal from the priority vehicular repeater system 110 within a predetermined period of time, the non-priority vehicular repeater system 120 assumes priority status. As known in the art, this is accomplished by updating the delay state counter such that the non-priority vehicular repeater system 120 has a delay state of zero. Once priority status is assumed, the previously non-priority vehicular repeater system 120 retransmits the voice signal and other received signals 131 via signal path 225 to the base station 150.

FIG. 4 illustrates a flow chart diagram 300 of the preferred method of the present invention wherein a priority vehicular repeater system 110 is desirous of maintaining priority when a second or non-priority vehicular repeater system 120 is activated. In this scenario, the priority vehicular repeater system 110 has already established itself at some optimal location and users would prefer to maintain the first system with optimal location as the priority vehicular repeater system. The method includes starting 301 the non-priority system when it reaches a predetermined location. The non-priority vehicular repeater system is activated 303 where it then transmits a radio frequency (RF) signal that includes a generated 305 analog notification tone to those other repeater units that may already be on-scene. The priority state of the non-priority repeater is then set 307 to “active” whereby normal repeater activity can begin 309. If, however, a priority vehicular repeater system wishes to maintain its status as the priority repeater at the scene, then it transmits an RF signal with an increment priority analog tone. This tone may then be detected by the non-priority vehicular repeater. If the increment priority tone is detected then a priority counter within the non-priority repeater is incremented and the non-priority vehicular repeater enters 313 an idle state. If no increment priority tone is detected then the non-priority vehicular repeater will decrement its counter and continue operation as normal 315 thereby becoming the new priority repeater.

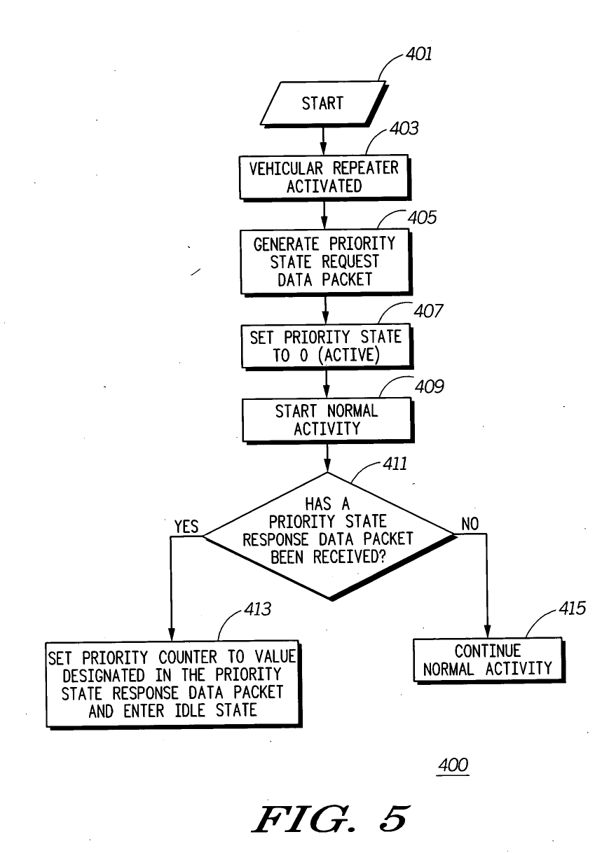

FIG. 5 is a flow chart diagram 400 of an alternative embodiment of the invention as shown in FIG. 4. In this embodiment, the vehicular repeater arriving on-scene is started 401 and activates 403 to become an active repeater. Rather than transmitting an analog priority state request in the form of a signal tone, a digital priority state request is generated 405 as a digital packet. The priority state is then set 407 to zero, i.e., the active state. This sets 409 or enables the vehicular repeater to act as the priority repeater where normal repeater activity is established. However, if another priority vehicular repeater is already on-scene and is desired to remain in a priority state, the newly arriving repeater monitors 411 for transmission of a digital state priority packet transmitted by the priority repeater on-scene. If a priority state data packet is received, a priority counter is set 413 to a value designated in the priority state response data packet whereby the newly arriving repeater enters an idle state. Conversely, if a priority state response is not received, then the newly arriving vehicular repeater continues 415 with normal repeater activity.

Thus, the present invention allows the first vehicular repeater on-scene to remain the active and/or priority repeater as other vehicular repeaters arrive at the same location. This allows the first arriving unit to control repeater communications for an accident scene or other critical location allowing users to place the repeater in the most optimal location. Other vehicular repeaters arriving on-scene will remain idle and not interfere with the operation of the priority repeater.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A communication system, comprising:
a portable radio that selectively transmits radio signals;
a first vehicular repeater system, comprising:
a first vehicular repeater adaptable to receive radio signals transmitted by the portable radio;
a first mobile radio, coupled to the first vehicular repeater, and adaptable to retransmit signals received by the first vehicular repeater;
wherein the first vehicular repeater has priority repeater status that signifies primary responsibility for repeating the radio signals transmitted by the portable radio, and wherein the first vehicular repeater is capable of transmitting a priority signal to indicate that it is to remain in priority repeater status;
a second vehicular repeater system, comprising:
a second vehicular repeater;
a second mobile radio, coupled to the second vehicular repeater, and responsive to retransmit signals received by the second vehicular repeater; and
wherein the second vehicular repeater system transmits a notification signal when activated and monitors to receive the priority signal by the first vehicular repeater.

2. The communication system of claim 1, wherein the priority radio signal is a tone signal.

3. The communications system of claim 2, wherein the tone is transmitted over a voice channel.

4. The communications system of claim 1, wherein the priority radio signal is a digital signal.

5. The communication system of claim 1, wherein the notification signal is a tone signal.

6. The communication system of claim 1, wherein the notification signal is a digital signal.

7. The communication system of claim 5, wherein the tone is transmitted over a voice channel.

8. The communications system of claim 1, wherein the second vehicular repeater system includes at least one counter for working with a receiver to switch between a priority and idle state based upon detection of the priority signal.

9. The communications system of claim 7, wherein the at one least counter is first initialized to act in the priority state and can then be incremented or decremented to active in the idle state.

10. The communications system as in claim 8, wherein a value of zero by the at least one counter is indicative of a priority state and a value of one by the at least one counter is indicative of an idle state.

11. A method for allowing a first vehicular repeater unit to maintain priority repeater status in a multi-unit vehicular repeater system comprising the steps of:
activating a first vehicular repeater system at a predetermined location;
activating a second vehicular repeater system at substantially the same predetermined location;
transmitting a notification signal by the second vehicular repeater system indicating presence at the predetermined location;
initiating normal repeater activity by the second vehicular repeater system;
receiving a priority signal at the second vehicular repeater system sent by the first vehicular repeater system; and
switching the second vehicular repeater system into an idle state based on receipt of the priority signal.

12. A method as in claim 11, wherein the step of transmitting a notification signal further includes the step of:
initializing a counter in the second vehicular repeater to a priority state.

13. A method as in claim 11, wherein the step of switching into an idle state includes the step of:
incrementing a counter in the second vehicular repeater from a priority state to an idle state in the second vehicular repeater in response to receipt of the priority signal.

14. A method as in claim 13, wherein the counter set to zero is indicative of a priority state and the counter set to one is indicative of an idle state.

15. A method as in claim 11, wherein the notification signal is an analog tone signal.

16. A method as in claim 11, wherein the notification signal is a digital signal.

17. A method as in claim 11, wherein the priority signal is an analog tone signal.

18. A method as in claim 11, wherein the priority signal is a digital signal.

19. A method for maintaining a first vehicular repeater system as a priority repeater upon the arrival of at least one additional vehicular repeater in the same operational area comprising the steps of:
activating the at least one additional vehicular repeater upon arrival at an operational area;
generating a radio frequency (RF) notification signal tone to other vehicular repeaters already in a priority state at the operational area;
setting at least one counter in the at least one additional vehicular repeater to an active state;
starting normal operational activities of the at least one additional repeater;
monitoring for an RF priority signal by the first vehicular repeater system; and switching the at least one counter to an idle state upon receipt of an RF priority signal from the first vehicular repeater.

20. A method for maintaining a first vehicular repeater system as a priority repeater as in claim 19, wherein the at least one additional vehicular repeater remains in a priority state if no RF priority signal is received.

21. A method for maintaining a first vehicular repeater system as a priority repeater as in claim 19, wherein the at least one counter is set to zero in a priority state and the at least one counter is set to one in an idle state.

22. A method for maintaining a first vehicular repeater system as a priority repeater as in claim 19, wherein the notification signal tone and priority signal tone are analog signals.

23. A method for maintaining a first vehicular repeater system as a priority repeater as in claim 19, wherein the notification signal tone and priority signal tone are digital packet signals.
